(19) United States
(12) Patent Application Publication
(10) Pub. No.: US 2024/0385815 A1
(43) Pub. Date: Nov. 21, 2024

(54) CODE CLEANING METHOD, APPARATUS, DEVICE AND MEDIUM

(71) Applicant: Beijing Zitiao Network Technology Co., Ltd., Beijing (CN)

(72) Inventor: Junyu YUE, Beijing (CN)

(21) Appl. No.: 18/665,326

(22) Filed: May 15, 2024

(30) Foreign Application Priority Data
May 15, 2023 (CN) 202310544933.6

(51) Int. Cl. G06F 8/41

(52) U.S. Cl. CPC G06F 8/427; G06F 8/4435

(57) ABSTRACT

Embodiments of the present disclosure provide a code cleaning method, apparatus, device, and medium. A specific implementation of the method includes: converting target code into a corresponding abstract syntax tree, determining, according to the abstract syntax tree, an assignment statement associated with a conditional judgement variable of a target conditional judgement statement in the target code, and determining the conditional judgement variable according to the assignment statement; and determining a useless conditional branch statement in the target conditional judgment statement according to the conditional judgement variable, and deleting the useless conditional branch statement from the target conditional judgment statement. By using the method, in code cleaning, even if the conditional judgement variable is not determined directly within a conditional judgement statement, an invalid conditional branch of the conditional judgement statement may also be removed.

### CROSS-REFERENCE

The present application claims priority to the Chinese Patent Application No. 202310544933.6, filed on May 15, 2023 and entitled “CODE CLEANING METHOD, APPARATUS, DEVICE AND MEDIUM”, the entirety of which is incorporated herein by reference.

### FIELD

Embodiments of the present disclosure relate to the technical field of code analysis and code management, and in particular, to a code cleaning method, apparatus, device and medium.

### BACKGROUND

In the existing solution for cleaning code, it is often required to directly obtain the conditional judgement variable for judging the executed conditional branch from the conditional judgment statement in the code, and determine, according to the conditional judgement variable, the code of which conditional branch statement in the conditional judgment statement that has to be cleaned. However, this solution relies on directly obtaining the conditional judgement variable in the conditional judgment statement. But in some scenarios, the conditional judgement variable cannot be obtained directly according to the conditional judgment statement in the code, and thus the conditional branch statement in the conditional judgment statement cannot be cleaned by using the foregoing solution.

Therefore, a new code cleaning method is required.

### SUMMARY

Embodiments of the present disclosure describe a code cleaning method, apparatus, device and medium.

According to a first aspect, a method for code cleaning is provided, including:
converting target code into a corresponding abstract syntax tree, determining, according to the abstract syntax tree, an assignment statement associated with a conditional judgement variable of a target conditional judgement statement in the target code, and determining the conditional judgement variable according to the assignment statement; and
determining a useless conditional branch statement in the target conditional judgment statement according to the conditional judgement variable, and deleting the useless conditional branch statement from the target conditional judgment statement.

According to a second aspect, an apparatus for code cleaning is provided, and the apparatus includes:
an assignment determining unit configured to convert target code into a corresponding abstract syntax tree, determine, according to the abstract syntax tree, an assignment statement associated with a conditional judgement variable of a target conditional judgement statement in the target code, and determine the conditional judgement variable according to the assignment statement; and
a code cleaning unit configured to determine a useless conditional branch statement in the target conditional judgment statement according to the conditional judgement variable, and delete the useless conditional branch statement from the target conditional judgment statement.

According to a third aspect, a computer readable storage medium is provided, and a computer program is stored on the storage medium, when the computer program is executed in a computer, the computer executes the method according to the first aspect.

According to a fourth aspect, an electronic device is provided, the electronic device includes a memory and a processor, wherein the memory stores an executable code therein, and when the processor executes the executable code, the method of the first aspect is implemented.

According to embodiments of the present disclosure, there is provided a code cleaning method, apparatus, device and medium. According to the code cleaning method, target code is converted into a corresponding abstract syntax tree; and an assignment statement associated with a conditional judgement variable of a target conditional judgement statement in the target code is determined according to the abstract syntax tree; then, a conditional judgement variable is determined according to the assignment statement, and a useless conditional branch statement in the target conditional judgment statement is deleted according to the conditional judgement variable. By using any one of the described method, apparatus, storage medium and electronic device, in code cleaning, even if the conditional judgement variable is not determined directly within a conditional judgement statement, an invalid conditional branch of the conditional judgement statement may also be removed.

### BRIEF DESCRIPTION OF THE DRAWINGS

FIG. 1 illustrates a schematic diagram of a conditional judgment statement to be cleaned;

FIG. 2 illustrates a schematic diagram of another conditional judgment statement to be cleaned;

FIG. 3 illustrates a schematic flowchart of a code cleaning method according to an embodiment of the present disclosure;

FIG. 4 illustrates a schematic diagram of calling an attribute of the target object by the assignment statement according to one embodiment of the present disclosure;

FIG. 5 illustrates a schematic diagram of calling a function of the target object by the assignment statement according to another embodiment of the present disclosure;

FIG. 6 illustrates a schematic diagram of deleting a conditional branch according to an embodiment of the present disclosure;

FIG. 7 illustrates a schematic diagram of deleting a conditional branch according to another embodiment of the present disclosure;

FIG. 8 illustrates a schematic block diagram of a code cleaning apparatus according to an embodiment of the present disclosure;

FIG. 9 illustrates a structural schematic diagram of an electronic device suitable for implementing an embodiment of the present disclosure;

FIG. 10 illustrates a structural schematic diagram of a storage medium suitable for implementing an embodiment of the present disclosure.

### DETAILED DESCRIPTION

The technical solutions provided by the present disclosure will be further described in detail below in conjunction with the accompanying drawings and embodiments. It should be understood that the specific embodiments described herein are only used to explain the related solution, rather than limit the present disclosure. In addition, it should be noted that, for ease of description, only parts related to the related solution are shown in the accompanying drawings. It should be noted that the embodiments of the present disclosure and the features of the embodiments can be combined with each other without conflict.

In the description of implementations of the present disclosure, the term “including” and its similar language should be understood as open-ended including, that is, “including but not limited to”. The term “based on” should be read as “based at least in part on.” The term “one implementation” or “the implementation” should be read as “at least one implementation”. The term “some implementations” should be understood as “at least some implementations.” Other explicit and implicit definitions may also be included below.

In the production process of a software application, as the software is updated and iterated or as the production stage of the software changes, the code of the application is usually cleaned, including deleting the code that has been invalid currently. For example, for an application, the lowest version of the software development kit (SDK) at which the application runs can be specified by setting the lowest version SDK on the user device. Furthermore, the code of the application includes, for example, a conditional judgement statement for determining a software development kit version (SDK Version) on the user device, so as to determine whether to start features for different SDK versions. If a higher-version SDK is required to run the application normally after the application is updated, a lowest SDK version (minSdk Version) corresponding to the application can be upgraded, and thus the application cannot be installed or run on a user device that is configured to have an SDK version lower than the minSdk Version. Thus, in the code of the application, the judgement code of the SDK version lower than the minSdK Version is useless. In another example, at the beginning of an application production process, it is difficult to determine the real preference of a user, thus users are often divided into different experimental groups (or referred to as comparison groups). The code of the application usually include feature setting code for different comparison groups, and the feature setting code of a specific comparison group to be reserved is determined according to an actual execution result. This code production can be referred to as an AB experiment (or a comparison group experiment). After the comparison group that needs to be reserved is determined, the feature setting code of the other comparison groups is useless, and thus the feature setting code of the other comparison groups may be deleted from the application code. The feature setting code for different comparison groups is often included in different conditional branch statements of a conditional judgment statement. Therefore, an invalid conditional branch statement (namely, a conditional branch statement corresponding to feature setting code of other control groups) may be deleted from the conditional judgment statements.

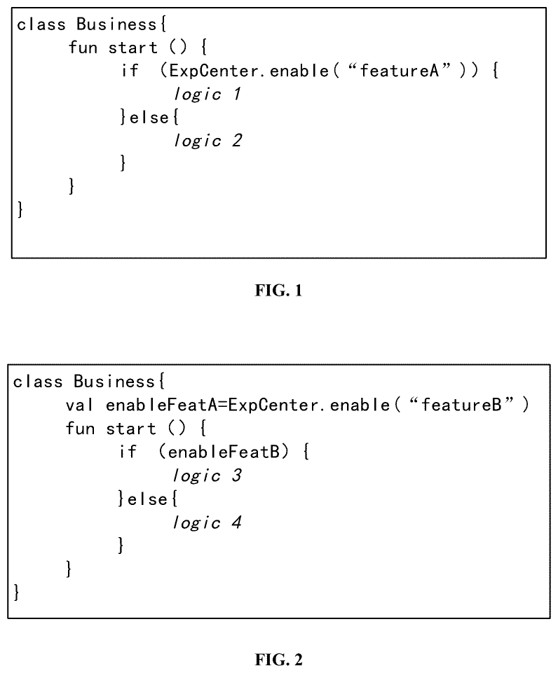

Invalid branches may be cleaned manually, but it consumes a lot of manpower and thus is often not efficient enough. Therefore, many software manufacturers wish to use a solution of automatically deleting invalid branches in code. According to an existing solution for automatically cleaning up code, by directly obtaining a conditional judgement variable for determining conditional branches in a conditional judgement statement, a useless conditional branch statement in the conditional judgement statement is determined and cleaned. FIG. 1 illustrates a schematic diagram of a conditional judgment statement to be cleaned. As shown in FIG. 1, for example, for a comparison group 1, feature A is started, and for a comparison group 2, feature A is not started. The value of the conditional judgement variable may be directly determined by the ExpCenter.enable (“featureA”) called in the conditional judgment statement if{ } . . . else{ }, for example, when the ExpCenter.enable (‘featureA’) is true, the step of starting the feature A (for example, the logic1) is executed. When the ExpCenter.enable (“featureA”) is false, a step of not starting the feature A (for example, logic2) is executed. Therefore, after it is determined to use the comparison group 1, for example, as the logic2 corresponding to comparison group 2 is invalid, a conditional branch statement when the ExpCenter.enable (“featureA”) is false may be deleted, that is, a conditional branch statement corresponding to the logic2.

However, such a solution has a problem in that it relies on the correct value of the conditional judgement variable directly obtained in the conditional judgement statement. In some scenarios, the correct value of the conditional judgement variable cannot be obtained directly according to the conditional judgment statement in the code, and thus the conditional branch statement in the conditional judgment statement cannot be cleaned by using the foregoing solution. FIG. 2 illustrates a schematic diagram of another conditional judgment statement to be cleaned. In the code as shown in FIG. 2, the value of the conditional judgement variable enableFeatB cannot be directly obtained according to the conditional judgment statement if{ } . . . else{ }, that is because the assignment statement of the enableFeatB is not in the conditional judgment statement, and the conditional judgment statement if{ } . . . else{ } only includes the enableFeatB itself, but do not include the assignment statement thereof, thus the correct value of the enableFeatB cannot be determined only in the conditional judgment statement. Hence, according to the existing code cleaning solution, conditional branch cleaning cannot be performed on the conditional judgment statement shown in FIG. 2. In addition, the existing code cleaning solution relies on directly obtaining the conditional judgement variable in the conditional judgment statement, which also limits the way of writing the conditional judgment statement and brings inconvenience in writing codes.

In order to solve the above technical problem, an embodiment of the present disclosure provides a code cleaning method. In some embodiments, target code may be converted into an abstract syntax tree, and then an assignment statement of a conditional judgement variable of a target conditional judgement statement is determined from the target code through the abstract syntax tree, and then the conditional judgement variable is determined according to the assignment statement. Further, a useless conditional branch statement in the target conditional judgment statement is determined based on the conditional judgement variable, and the useless conditional branch statement is deleted from the conditional branch statement. The advantages of the method include, on the one hand, according to a conventional syntax rule, the assignment statement of the conditional judgement variable may often be out of the conditional judgment statement; whereas, according to the method, a conditional judgement variable can be determined by means of an assignment statement other than a conditional judgement statement, and invalid branches can be cleaned according to the conditional judgement variable. Compared with the existing code cleaning solution which relies on directly determining a conditional judgement variable in a conditional judgement statement, by using the method according to the present application, an invalid conditional branch can also be cleaned in the case where the conditional judgement variable cannot be directly determined in the conditional judgement statement, thereby greatly expanding the range of cleanable codes. On the other hand, since the existing code cleaning solution relies on determining the conditional judgement variable directly in the conditional judgment statement, and it usually needs to set a specific way of code writing so as to determine the conditional judgement variable directly in the conditional judgment statement. For example, as shown in FIG. 1, a function call ExpCenter.enable (“featureA”) that can directly obtain the conditional judgment variable is embedded in the conditional judgment statement if (ExpCenter.enable (“featureA”)) shown in FIG. 1. However, such a specific way of code writing requires the encoding personnel to put extra effort to conform to its rules, and other ways of code writing allowed in a conventional syntax cannot be used, which is also inconvenient for the encoding personnel. In addition, it is easy to generate a situation that code cleaning cannot be performed because the situation does not comply with the specific way of code writing. In addition, the embodiment of the present disclosure provides a code cleaning method, which can trace a assignment statement other than the conditional judgment statement, so that invalid code branches can also be cleaned without using the above specific way of code writing, thereby greatly facilitating code writing of the encoding personnel. Furthermore, the problem that the code cannot be cleaned up because the code does not conform to a specific way of code writing is overcame.

The detailed process of this method is described further below.

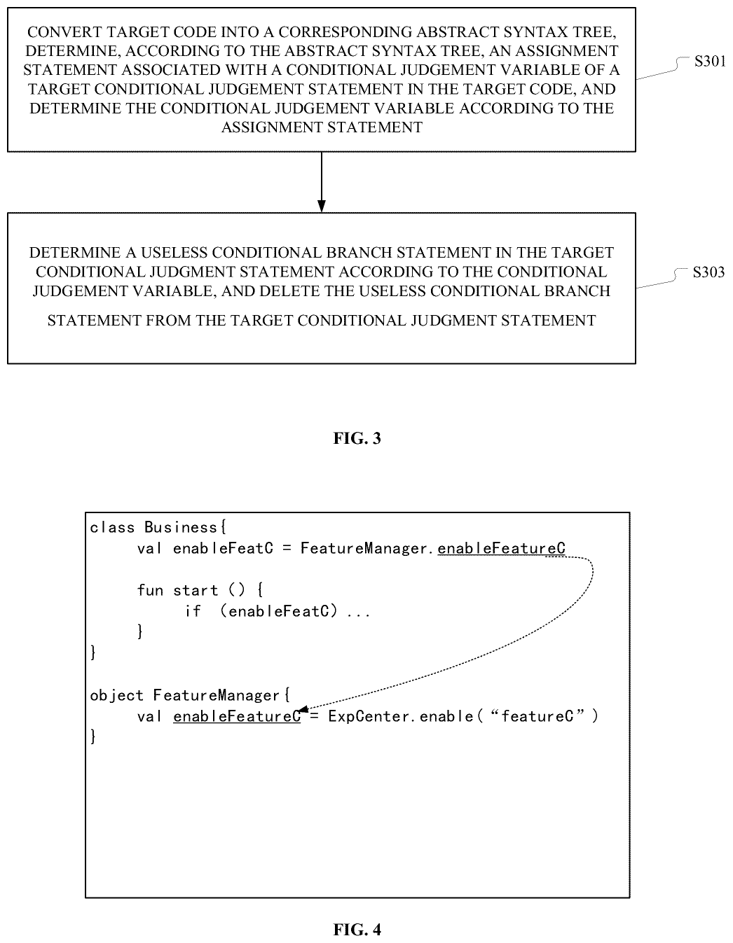

FIG. 3 illustrates a schematic flowchart of a code cleaning method according to an embodiment of the present disclosure. As shown in FIG. 3, the method at least includes the following steps:
step S301, converting target code into a corresponding abstract syntax tree, determining, according to the abstract syntax tree, an assignment statement associated with a conditional judgement variable of a target conditional judgement statement in the target code, and determining the conditional judgement variable according to the assignment statement;
Step S303: determining a useless conditional branch statement in the target conditional judgment statement according to the conditional judgement variable, and deleting the useless conditional branch statement from the target conditional judgment statement.

First, in step S301, the target code is converted into the corresponding abstract syntax tree; the assignment statement associated with the conditional judgement variable of the target conditional judgement statement in the target code is determined according to the abstract syntax tree; and the conditional judgement variable is determined according to the assignment statement. In different embodiments, the target code may be various software products or applications, or program code for various specific purposes. In an example, the target code may also be program source code. In different embodiments, the target code may also be program code written based on different programming languages, which is not limited in this specification.

An abstract syntax tree (AST), or a syntax tree for short, is an abstract representation of a syntax structure of source code. It represents a syntax structure of a programming language in the form of a tree, and each node on the tree represents a structural element in the source code, for example, a function, a variable, and an expression. After the target code is converted into the corresponding abstract syntax tree, for example, an assignment statement of the conditional judgement variable may be determined by traversing the abstract syntax tree. For example, in different embodiments, the specific algorithms for traversing the abstract syntax tree to determine the assignment statement may be different, which is not limited in this specification. In an embodiment, the target code may be converted into the corresponding abstract syntax tree according to an encoding language of the target code by using a compiler or an interpreter corresponding to the encoding language. As described above, the encoding languages of the target code in different embodiments may be different. Therefore, in different embodiments, the target codes may be converted into corresponding abstract syntax trees by a compiler or an interpreter corresponding to different coding languages, which is not limited in the specification.

The conditional judgment variable may be configured to determine which conditional branch statement in the conditional judgment statement being actually executed. Specifically, the conditional judgement variable can be determined according to a conditional expression. In different embodiments, the conditional expression may include one or more of a condition variable, a return value obtained by calling a function and a return value obtained by calling an object attribute. In one embodiment, the target conditional judgment statement does not include an assignment statement associated with the conditional judgement variable. Therefore, the assignment statement for the conditional judgement variable can be determined from outside the target conditional judgment statement, and the conditional judgement variable can be determined according to the assignment statement. For example, in FIG. 2, the assignment statement val enableFeatA=ExpCenter.enable (“featureB”) of the conditional judgement variable (conditional variable) enableFeatA is out of the conditional judgment statement if{ } . . . else{ }. Therefore, the assignment statement val enableFeatA=ExpCenter.enable (“featureB”) of the condition variable enableFeatA may be determined from outside the conditional judgment statement, and the value of the conditional judgement variable enableFeatA is determined according to the assignment statement.

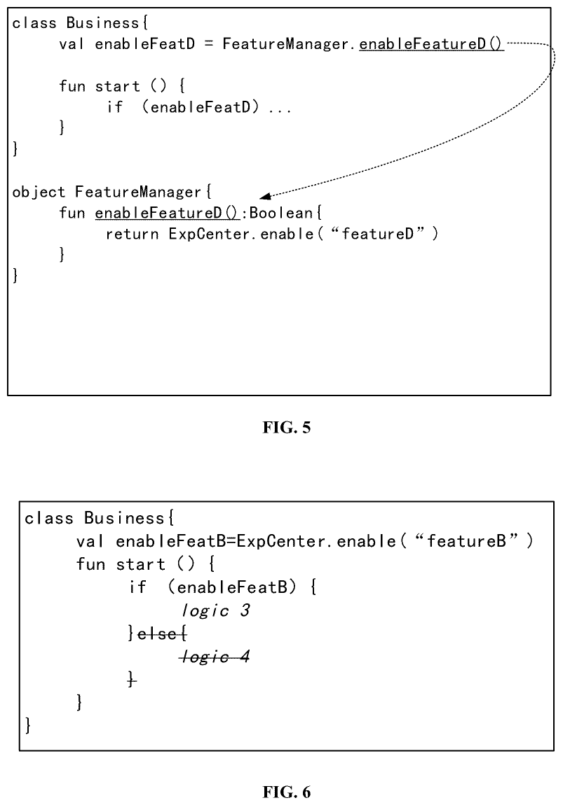

In one embodiment, the assignment statement may also call a function or an attribute of the target object, and therefore, the conditional judgement variable may be determined according to a return value of the called function or attribute of the target object. Here, the target object generally refers to a program object, the program object is a package of a data structure and an algorithm, and program objects belonging to the same category may share the attribute and function of this program category. FIG. 4 illustrates a schematic diagram of calling the attribute of the target object by the assigning statement according to one embodiment of the present disclosure. FIG. 4 illustrates a schematic diagram of calling the attribute of the target object by the assigning statement according to one embodiment of the present disclosure. As shown in FIG. 4, the assignment statement val enableFeatC=FeatureManager.enableFeatureC of the conditional judgement variable (condition variable) enableFeatC calls the attribute enableFeatureC of the target object FeatureManager (namely, FeatureManager.enableFeatureC) to assign a value to the enableFeatC. Therefore, the value of enableFeatC may be determined according to the return value obtained by calling FeatureManager.enableFeatureC. FIG. 5 illustrates a schematic diagram of calling a function of the target object by the assignment statement according to another embodiment of the present disclosure. As shown in FIG. 5, the assignment statement val enableFeatD=FeatureManager.enableFeatureD( )) of the conditional judgement variable (condition variable) enableFeatD calls the function enableFeatureD( ) of the target object FeatureManager (namely, FeatureManager.enableFeatureD( )) to assign a value to the enableFeatD. Therefore, the value of the enableFeatD may be determined according to the return value obtained by calling the FeatureManager.enableFeatureD( ). In this way, the initialization path of the conditional judgement variable may be traced deeply, for example, the conditional judgement variable->an assignment statement->a function/attribute called by the assignment statement, so that the conditional judgement variable may be determined when the assignment statement of the conditional judgement variable calls an object thereof.

Then, in step S303, a useless conditional branch statement in the target conditional branch statement is determined according to the conditional judgment variable, and the useless conditional branch statement is deleted from the target conditional judgment statement.

Conventionally, the target conditional judgment statement may include at least one conditional branch statement. In this step, according to the conditional judgment variable obtained in step S301, a useless conditional branch statement in the target conditional judgement statement is determined, and the useless conditional branch statement is deleted from the target conditional judgement statement.

As previously described, the target code can be various software products or applications, or program code for various specific purposes. Therefore, in different embodiments, the conditional branch statements in the target conditional judgment statements may respectively correspond to conditional branch statements of different specific judgment purposes, which is not limited in this specification. For example, in one embodiment, the target conditional judgment statement may include a plurality of conditional branch statements, and the plurality of conditional branch statements respectively correspond to a plurality of version numbers of a software development kit. In addition, a useless version number in the plurality of version numbers and a useless conditional branch statement corresponding to the useless version number may be determined according to the conditional judgement variable, and the useless conditional branch statement is deleted from the plurality of conditional branch statements. In a specific embodiment, the useless version number is less than a lowest version number of a software development kit on a target device. By deleting the conditional branch corresponding to the useless version number, the target code can be simplified without affecting the function of the target code, thereby reducing resources consumed by compiling/running the target code, and improving the running efficiency and maintainability of the target code.

In another embodiment, the target conditional judgment statement includes a plurality of conditional branch statements, and the plurality of conditional branch statements respectively correspond to a plurality of code comparison groups of a code comparison experiment. In addition, a useless code comparison group in the plurality of code comparison groups and a useless conditional branch statement corresponding to the useless code comparison group are determined according to the conditional judgment variable, and the useless conditional branch statement is deleted from the plurality of conditional branch statements. In a specific embodiment, the plurality of conditional branch statements may respectively correspond to feature configurations associated with the plurality of code comparison groups. By deleting a conditional branch corresponding to an invalid code comparison group, the target code can be simplified without affecting the function of the target code, thereby reducing resources consumed by compiling/running the target code, and improving the running efficiency and maintainability of the target code.

As described above, in different embodiments, target code may be written based on different programming languages. In different programming statements, different kinds of conditional judgment statements may be included. For example, in one programming language, the conditional judgment statement may include an if statement, a when statement. In another programming language, the conditional judgment statement may include an if statement, a switch statement. In different embodiments, the useless conditional branch statement may be deleted according to expression ways of different specific conditional judgment statements in different programming languages, which is not limited in this specification.

In one embodiment, the useless conditional branch statement can be deleted directly from the target conditional judgement statement. FIG. 6 illustrates a schematic diagram of deleting a conditional branch according to an embodiment of the present disclosure. As shown in FIG. 6, after it is determined that the enableFeatB is true, so that a conditional branch statement corresponding to the enableFeatB being false is an invalid conditional branch (namely, a conditional branch statement that includes logic4), the conditional branch statement that includes logic2 may be deleted.

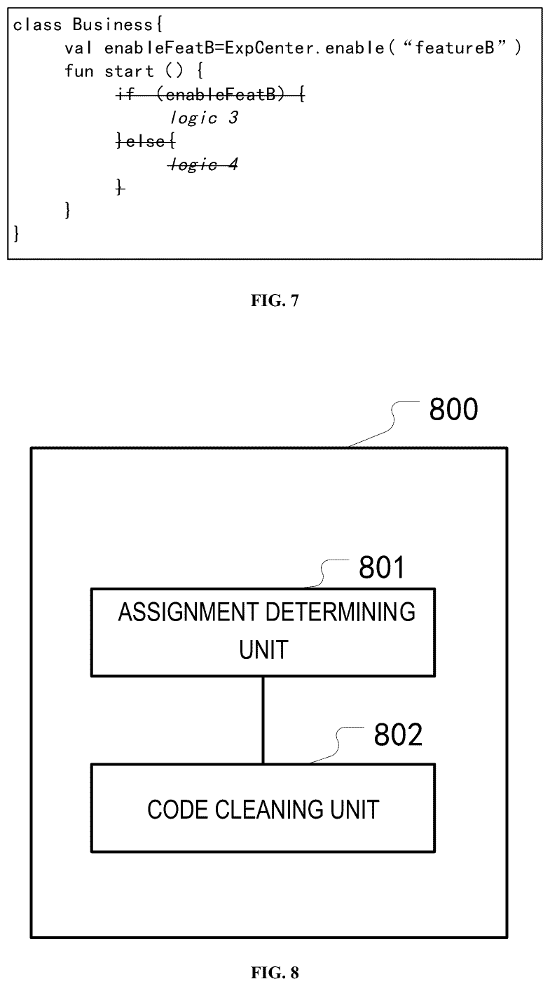

In another embodiment, if there is one valid conditional branch statement other than the useless conditional branch statement in the target conditional judgment statement, a code block included in the valid conditional branch statement may also be reserved, and other content except the code block in the target conditional judgment statement is deleted. FIG. 7 illustrates a schematic diagram of deleting a conditional branch according to another embodiment of the present disclosure. As shown in FIG. 7, in a case in which it is determined that there is one valid conditional branch statement (a conditional branch statement corresponding to an enable FeatB being true) other than the useless conditional branch statement, a code block (logic 3) included in the valid conditional branch statement may be reserved, and other content included in a target conditional judgment statement may be deleted. In this way, the cleaned code can be further simplified while ensuring the code logic.

FIG. 8 is a schematic block diagram of a code cleaning apparatus according to an embodiment of the present disclosure. The apparatus is configured to execute the method shown in FIG. 3. As shown in FIG. 8, the apparatus 800 includes:

An assignment determining unit 801 configured to convert target code into a corresponding abstract syntax tree, determine, according to the abstract syntax tree, an assignment statement associated with a conditional judgement variable of a target conditional judgement statement in the target code, and determine the conditional judgement variable according to the assignment statement; and

A code cleaning unit 802 configured to determine a useless conditional branch statement in the target conditional judgment statement according to the conditional judgement variable, and delete the useless conditional branch statement from the target conditional judgment statement.

An embodiment of the present disclosure further provides an electronic device, including a memory and a processor. The memory stores executable code therein. When the processor executes the executable code, the method as shown in FIG. 3 is implemented.

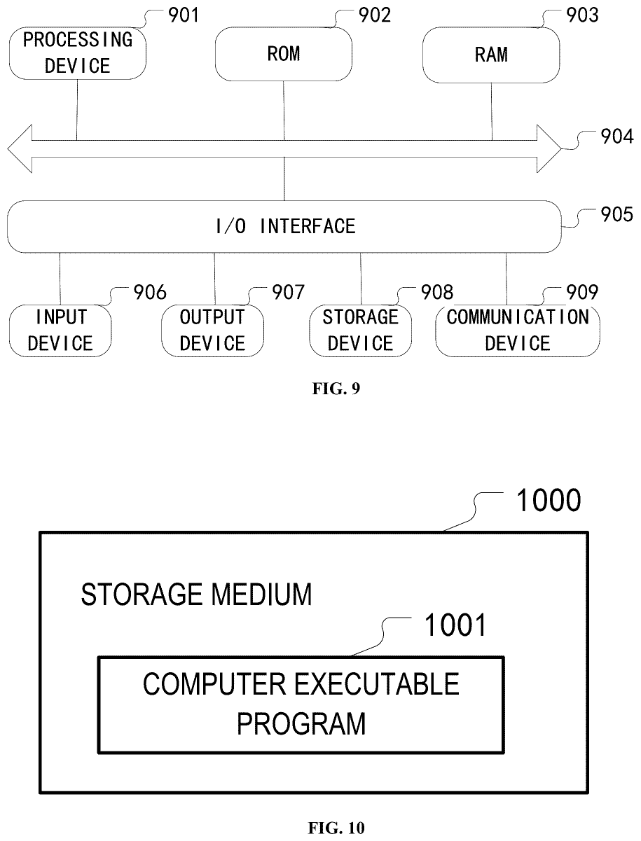

Reference may also be made to FIG. 9, FIG. 9 illustrates a schematic structural diagram of an electronic device 800 suitable for implementing an embodiment of the present application. The electronic device 900 shown in FIG. 9 is merely an example and should not bring any limitation to the functions and scope of use of embodiments of the present application.

As shown in FIG. 9, the electronic device 900 may include a processing device (e. g., a central processor, graphics processor, etc.) 901. The above processing device 901 may be a general-purpose processor, a digital signal processor (DSP), a microprocessor, or a microcontroller, and may further include an Application Specific Integrated Circuit (ASIC), a Field-Programmable Gate Array (FPGA) or other programmable logic device, a discrete gate or transistor logic device and discrete hardware components. It may perform various appropriate actions and processes based on programs stored in Read-Only Memory (ROM) 902 or loaded from storage device 908 into Random Access Memory (RAM) 903. In the RAM 903, various programs and data necessary for the operation of the electronic device 900 are also stored. The processing device 901, ROM 902, and RAM 903 are connected to each other through a bus 904. An Input/Output I/O interface 905 is also connected to the bus 904.

In general, Typically, the following devices can be connected to I/O interface 905: input devices 906 including, for example, touch screens, touchpads, keyboards, mice, etc.; output devices 907 including liquid crystal displays (LCDs), speakers, vibrators, etc.; storage devices 908 including magnetic tapes, hard disks, etc.; and a communication device 909. The communication device 909 may allow the electronic device 900 to communicate with other devices wirelessly or wirelessly to exchange data. Although FIG. 7 illustrates an electronic device 900 with multiple devices, it shall be understood that it is not required to implement or have all of the devices shown. More or fewer devices can be implemented or provided instead. Each block shown in FIG. 9 may represent a single device or multiple devices as desired.

In particular, according to embodiments of the present application, the process described above with reference to the flowchart can be implemented as a computer software program. For example, an embodiment of the present application includes a computer program product that includes a computer program carried on a computer-readable medium, where the computer program includes program code for performing the method shown in the flowchart. In such an embodiment, the computer program can be downloaded and installed from a network through the communication device 909, or installed from the storage device 908, or installed from the ROM 902. When the computer program is executed by the processing device 901, the above functions defined in the code cleaning method of the embodiment of the present application are performed.

Embodiments of the present disclosure further provide a computer readable storage medium, on which a computer program is stored, and when being executed in a computer, the computer program causes the computer execute the code cleaning method as shown in FIG. 1 provided by the embodiments of the present application. FIG. 10 is a schematic diagram of a storage medium for implementing an embodiment of the present application. For example, as shown in FIG. 10, the storage medium 1000 may be a non-transitory computer readable storage medium, and is configured to store a non-transitory computer executable instruction 1001. The code cleaning method provided by the embodiments of the present application can be implemented when the non-transitory computer-executable instruction 1001 is executed by a processor. For example, when the non-transitory computer-executable instruction 1001 is executed by a processor, one or more steps of the code cleaning method provided by the embodiments of the present application can be executed. For example, the storage medium 1000 may be applied to the foregoing electronic device, and for example, the storage medium 1000 may include a memory in the electronic device. For the description of the storage medium 1000, reference may be made to the description of the memory in the embodiment of the electronic device, and details are not repeatedly described herein. For specific functions and technical effects of the storage medium 1000, reference may be made to the description about the code cleaning method provided in the embodiment of the present application, and details are not repeatedly described herein.

It should be noted that the computer-readable medium described in the embodiment of the present disclosure can be a computer-readable signal medium or a computer-readable storage medium, or any combination thereof. The computer-readable storage medium can be, for example, but not limited to, an electrical, magnetic, optical, electromagnetic, infrared, or semiconductor system, apparatus, or device, or any combination thereof. Specific examples of computer-readable storage media may include but are not limited to: an electrical connection with one or more wires, memory card of an intelligent phone, a storage component of a tablet, a portable computer disk, a hard disk of a PC, random access memory (RAM), read-only memory (ROM), an erasable programmable read-only memory (EPROM) or flash memory, an optical fiber, a portable compact disk read-only memory (CD-ROM), an optical storage device, a magnetic storage device, or any suitable combination thereof. In the embodiments of the present disclosure, a computer-readable storage medium may be any tangible medium containing or storing a program that can be used by an instruction execution system, apparatus, or device, or can be used in combination with an instruction execution system, apparatus, or device. In the embodiments of the present disclosure, a computer-readable signal medium can include a data signal propagated in baseband or as part of a carrier wave, which carries computer-readable program code therein. Such propagated data signals may take many forms, including but not limited to electromagnetic signals, optical signals, or any suitable combination thereof. A computer-readable signal medium may also be any computer readable medium other than a computer-readable storage medium, which can send, propagate, or transmit programs for use by or in conjunction with instruction execution systems, apparatus, or devices. The program code contained on the computer-readable medium may be transmitted using any suitable medium, including but not limited to: wires, optical cables, RF (radio frequency), etc., or any suitable combination thereof.

The computer-readable medium can be included in the electronic device, or it can exist alone without being assembled into the electronic device. The above-mentioned computer-readable medium carries one or more programs, and when the above-mentioned one or more programs are executed by a server, the electronic device executes the code cleaning method of the embodiments of the present disclosure as above.

Computer program codes for performing the operations of the embodiments of the present disclosure may be written in one or more programming languages or a combination thereof, including Object Oriented programming languages-such as Java, Smalltalk, C++, and also conventional procedural programming languages-such as “C” or similar programming languages. The program code may be executed entirely on the user's computer, partially executed on the user's computer, executed as a standalone software package, partially executed on the user's computer and partially on a remote computer, or entirely on a remote computer or server. In the case of involving a remote computer, the remote computer may be any kind of network-including local area network (LAN) or wide area network (WAN)-connected to the user's computer, or may be connected to an external computer (e.g., through an Internet service provider to connect via the Internet).

The flowcharts and block diagrams in the accompanying drawings illustrate the architecture, functions, and operations of possible implementations of the system, method, and computer program product according to various embodiments of the present disclosure. In this regard, each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions. The units involved in the embodiments of the present disclosure may be implemented by means of software or hardware, and the name of the unit does not constitute a limitation on the unit itself in a certain case. The functions described herein above can be performed at least in part by one or more hardware logic components. For example, without limitation, exemplary types of hardware logic components that may be used include: Field Programmable Gate Arrays (FPGAs), Application Specific Integrated Circuits (ASICs), Application Specific Standard Parts (ASSPs), System on Chip (SOCs), Complex Programmable Logic Devices (CPLDs), and so on.

The embodiments in this description are described in a progressive manner, the same or similar parts of the embodiments may refer to each other, and each embodiment focuses on differences from other embodiments. In particular, for the embodiments of the storage medium and the computing device, since they are basically similar to the method embodiments, the description thereof is relatively simple, and for the relevant parts, reference may be made to the partial description of the method embodiments.

The above description is only embodiments of this disclosure and an explanation of the technical principles used. Those skilled in the art should understand that the scope of the disclosure involved in this disclosure is not limited to technical solutions composed of specific combinations of the above technical features, but should also covers other technical solutions formed by arbitrary combinations of the above technical features or their equivalent features without departing from the above disclosure concept. For example, technical solutions formed by replacing the above features with (but not limited to) technical features with similar functions disclosed in this disclosure. In addition, although multiple operations are depicted in a specific order, this should not be understood as requiring these operations to be performed in the specific order shown or in a sequential order. In certain environments, multitasking and parallel processing may be advantageous. Similarly, although multiple implementation details are included in the above discussion, these should not be construed as limiting the scope of the present disclosure. Some features described in the context of individual embodiments can also be implemented in combination in a single embodiment. Conversely, multiple features described in the context of a single embodiment can also be implemented in multiple embodiments separately or in any suitable sub-combination.

The objectives, technical solutions, and beneficial effects of the embodiments of the present application are described in detail in the foregoing specific implementations. Although the subject matter has been described in language specific to structural features and/or methodological logical actions, it should be understood that the subject matter defined in the appended claims is not necessarily limited to the specific features or actions described above. On the contrary, the specific features and actions described above are merely example forms of implementing the claims. It should be understood that the foregoing descriptions are merely specific implementations of the embodiments of the present disclosure, but are not intended to limit the scope of protection of the present disclosure. Any modification, equivalent replacement, or improvement made on the basis of the technical solutions of the present disclosure shall belong to the scope of protection of the present disclosure.

What is claimed is:

1. A method for code cleaning, comprising:
converting target code into a corresponding abstract syntax tree, determining, according to the abstract syntax tree, an assignment statement associated with a conditional judgement variable of a target conditional judgement statement in the target code, and determining the conditional judgement variable according to the assignment statement; and
determining a useless conditional branch statement in the target conditional judgment statement according to the conditional judgement variable, and deleting the useless conditional branch statement from the target conditional judgment statement.

2. The method of claim 1, wherein the target conditional judgment statement comprises a plurality of conditional branch statements, and the plurality of conditional branch statements respectively correspond to a plurality of code comparison groups of a code comparison experiment;
determining the useless conditional branch statement in the target conditional judgment statement according to the conditional judgement variable, and deleting the useless conditional branch statement from the target conditional judgment statement comprising:
determining, according to the conditional judgement variable, a useless code comparison group from the plurality of code comparison groups and a useless conditional branch statement corresponding to the useless code comparison group; and deleting the useless conditional branch statement from the plurality of conditional branch statements.

3. The method of claim 2, wherein the plurality of conditional branch statements respectively corresponding to the plurality of code comparison groups of the code comparison experiment comprises:
the plurality of conditional branch statements respectively correspond to feature configurations associated with the plurality of code comparison groups.

4. The method of claim 1, wherein the target conditional judgment statement comprises a plurality of conditional branch statements, and the plurality of conditional branch statements respectively correspond to a plurality of version numbers of a software development kit;
determining the useless conditional branch statement in the target conditional judgment statement according to the conditional judgement variable, and deleting the useless conditional branch statement from the target conditional judgment statement comprising:
determining, according to the conditional judgement variable, a useless version number from the plurality of version numbers and a useless conditional branch statement corresponding to the useless version number, and deleting the useless conditional branch statement from the plurality of conditional branch statements.

5. The method of claim 4, wherein the useless version number is less than a lowest version number of a software development kit on a target device.

6. The method of claim 1, wherein the target conditional judgment statement does not comprise the assignment statement associated with the conditional judgement variable.

7. The method of claim 1, wherein the assignment statement calls a function or an attribute of a target object, and determining the conditional judgement variable according to the assignment statement comprises:
determining the conditional judgement variable according to a return value of the called function or the called attribute of the target object.

8. The method of claim 1, wherein deleting the useless conditional branch statement from the target conditional judgment statement comprises:
in response to that there is one valid conditional branch statement other than the useless conditional branch statement in the target conditional judgment statement, reserving a code block included in the valid conditional branch statement, and deleting other content in the target conditional judgment statement except the code block.

9. The method of claim 1, wherein converting the target code into the corresponding abstract syntax tree comprises:
according to an encoding language of the target code, converting the target code into the corresponding abstract syntax tree by using a compiler or interpreter corresponding to the encoding language.

10. A non-transitory computer readable storage medium having which a computer program stored thereon, wherein the program, when executed in a computer, perform a method comprising:
converting target code into a corresponding abstract syntax tree, determining, according to the abstract syntax tree, an assignment statement associated with a conditional judgement variable of a target conditional judgement statement in the target code, and determining the conditional judgement variable according to the assignment statement; and
determining a useless conditional branch statement in the target conditional judgment statement according to the conditional judgement variable, and deleting the useless conditional branch statement from the target conditional judgment statement.

11. The non-transitory computer readable storage medium of claim 10, wherein the target conditional judgment statement comprises a plurality of conditional branch statements, and the plurality of conditional branch statements respectively correspond to a plurality of code comparison groups of a code comparison experiment;
determining the useless conditional branch statement in the target conditional judgment statement according to the conditional judgement variable, and deleting the useless conditional branch statement from the target conditional judgment statement comprising:
determining, according to the conditional judgement variable, a useless code comparison group from the plurality of code comparison groups and a useless conditional branch statement corresponding to the useless code comparison group; and deleting the useless conditional branch statement from the plurality of conditional branch statements.

12. An electronic device, comprising a memory and a processor, wherein the memory stores executable code therein, and wherein the executable code, when executed by the processor, cause acts to be implemented, the acts comprising:
converting target code into a corresponding abstract syntax tree, determining, according to the abstract syntax tree, an assignment statement associated with a conditional judgement variable of a target conditional judgement statement in the target code, and determining the conditional judgement variable according to the assignment statement; and
determining a useless conditional branch statement in the target conditional judgment statement according to the conditional judgement variable, and deleting the useless conditional branch statement from the target conditional judgment statement.

13. The electronic device of claim 12, wherein the target conditional judgment statement comprises a plurality of conditional branch statements, and the plurality of conditional branch statements respectively correspond to a plurality of code comparison groups of a code comparison experiment;
determining the useless conditional branch statement in the target conditional judgment statement according to the conditional judgement variable, and deleting the useless conditional branch statement from the target conditional judgment statement comprising:
determining, according to the conditional judgement variable, a useless code comparison group from the plurality of code comparison groups and a useless conditional branch statement corresponding to the useless code comparison group; and deleting the useless conditional branch statement from the plurality of conditional branch statements.

14. The electronic device of claim 13, wherein the plurality of conditional branch statements respectively corresponding to the plurality of code comparison groups of the code comparison experiment comprises:
the plurality of conditional branch statements respectively correspond to feature configurations associated with the plurality of code comparison groups.

15. The electronic device of claim 12, wherein the target conditional judgment statement comprises a plurality of conditional branch statements, and the plurality of conditional branch statements respectively correspond to a plurality of version numbers of a software development kit;
determining the useless conditional branch statement in the target conditional judgment statement according to the conditional judgement variable, and deleting the useless conditional branch statement from the target conditional judgment statement comprising:
determining, according to the conditional judgement variable, a useless version number from the plurality of version numbers and a useless conditional branch statement corresponding to the useless version number, and deleting the useless conditional branch statement from the plurality of conditional branch statements.

16. The electronic device of claim 15, wherein the useless version number is less than a lowest version number of a software development kit on a target device.

17. The electronic device of claim 12, wherein the target conditional judgment statement does not comprise the assignment statement associated with the conditional judgement variable.

18. The electronic device of claim 12, wherein the assignment statement calls a function or an attribute of a target object, and determining the conditional judgement variable according to the assignment statement comprises:
determining the conditional judgement variable according to a return value of the called function or the called attribute of the target object.

19. The electronic device of claim 12, wherein deleting the useless conditional branch statement from the target conditional judgment statement comprises:
in response to that there is one valid conditional branch statement other than the useless conditional branch statement in the target conditional judgment statement, reserving a code block included in the valid conditional branch statement, and deleting other content in the target conditional judgment statement except the code block.

20. The electronic device of claim 12, wherein converting the target code into the corresponding abstract syntax tree comprises:
according to an encoding language of the target code, converting the target code into the corresponding abstract syntax tree by using a compiler or interpreter corresponding to the encoding language.
